(19) United States
(12) Patent Application Publication
(10) Pub. No.: US 2015/0000298 A1
(43) Pub. Date: Jan. 1, 2015

(54) FUEL CONDITIONER, COMBUSTOR AND GAS TURBINE IMPROVEMENTS

(71) Applicant: Advanced Green Technologies, LLC, Chandler, AZ (US)

(72) Inventor: Roy Edward McAlister, Phoenix, AZ (US)

(73) Assignee: ADVANCED GREEN TECHNOLOGIES, LLC, Chandler, AZ (US)

(21) Appl. No.: 14/137,585

(22) Filed: Dec. 20, 2013

Related U.S. Application Data
(60) Provisional application No. 61/788,756, filed on Mar. 15, 2013.

(51) Int. Cl. F02C 3/20; F02C 7/16; F02C 7/224; F02C 3/30; F02C 7/22

(52) U.S. Cl. CPC F02C 3/20; F02C 3/30; F02C 7/22; F02C 7/224; F02C 7/16
USPC 60/775; 415/175; 60/39.12; 60/740; 60/736; 60/747; 60/39.5; 60/772; 60/780

(57) ABSTRACT

Advanced gas turbines and associated components, systems and methods are disclosed herein. A gas turbine configured in accordance with a particular embodiment includes a rotor operably coupled to a shaft and a stator positioned adjacent to the rotor. A coolant line extends at least partially through the stator to transfer heat out of an air flow within a compressor section of the gas turbine.

### CROSS-REFERENCE TO RELATED APPLICATION(S) INCORPORATED BY REFERENCE

The present application claims priority to U.S. Provisional Patent Application No. 61/788,756, entitled “FUEL CONDITIONER, COMBUSTOR AND GAS TURBINE IMPROVEMENTS,” and filed Mar. 15, 2013, which is incorporated herein in its entirety by reference.

### TECHNICAL FIELD

The present disclosure is directed generally to gas turbine improvements, including fuel conditioners, combustors and associated systems and methods.

### BACKGROUND

Gas turbines of various designs provide power for electrical generators, aircraft, ships and other transportation systems. For many applications, gas turbines provide several advantages over other internal combustion engine designs. However, although modern gas turbines operate at relatively high efficiency, increased efficiencies could greatly improve performance and reduce operational costs.

### BRIEF DESCRIPTION OF THE DRAWINGS

FIG. 1 is a partially schematic cross-sectional view of a gas turbine or turbine 100 having a thermochemical regeneration (TCR) system 102, a compressor cooling system 104 and a fuel injection system 106 configured in accordance with an embodiment of the present disclosure.

FIG. 2 is a schematic cross-sectional view of a reactor for thermochemical regeneration configured in accordance with an embodiment of the present disclosure.

FIG. 3 is a cross-sectional schematic view of an injector-igniter configured in accordance with an embodiment of the present disclosure.

### DETAILED DESCRIPTION

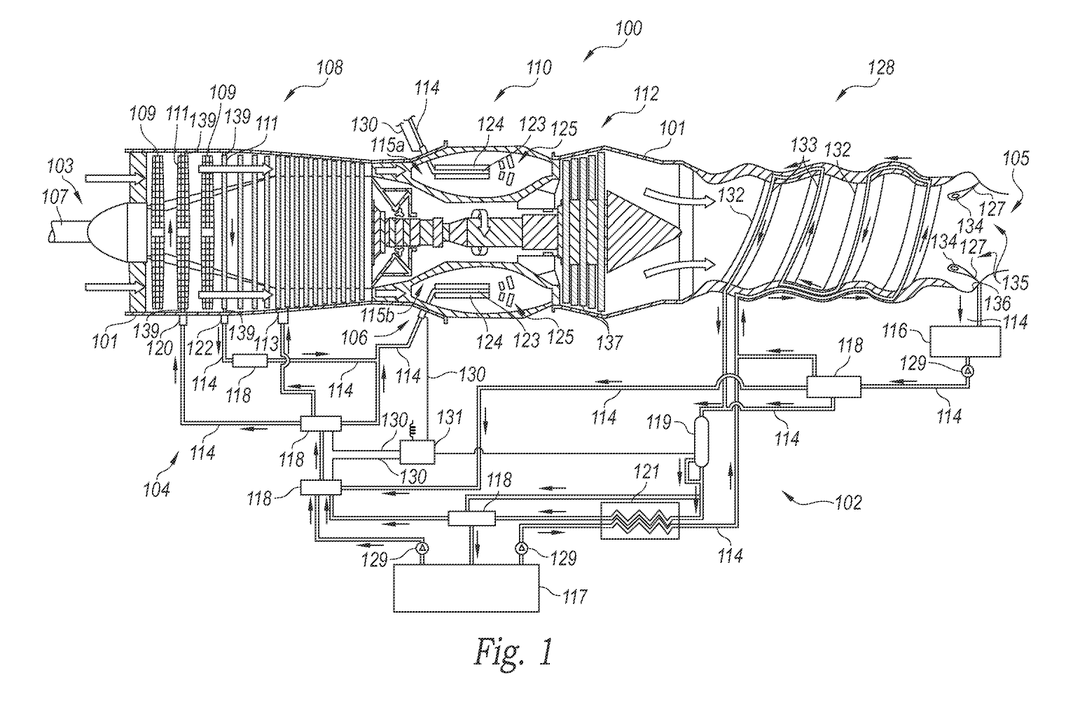

The following disclosure describes advanced gas turbines and associated components, systems and methods. As described in greater detail below, gas turbines configured in accordance with the present disclosure can include thermochemical regeneration systems, compressor cooling systems, fuel injection systems and/or other systems or components that can increase turbine efficiency and/or power output. An efficiency increase in a particular gas turbine may enable a greater power output for a given amount of fuel. However, as used in reference to the gas turbines and associated systems and components herein, the terms efficiency and power output refer generally to gas turbine performance with respect to fuel efficiency, power output, and/or other operational parameters, and are not limited strictly to any particular measurement of performance, including either efficiency or power output. Certain details are set forth in the following description and in FIGS. 1-3 to provide a thorough understanding of various embodiments of the disclosure. However, other details describing well-known structures and systems often associated with turbines, compressors, fuel injectors, and/or other aspects of gas turbines are not set forth below to avoid unnecessarily obscuring the description of various embodiments of the disclosure.

Many of the details, dimensions, angles, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below. Furthermore, certain aspects of the following disclosure described in the context of particular embodiments may be combined or eliminated in other embodiments.

In the Figures, identical reference numbers identify identical or at least similar elements. To facilitate the discussion of any particular element, the most significant digit or digits of any reference number refers to the Figure in which that element is first introduced. For example, element 110 is first introduced and discussed with reference to FIG. 1.

Gas turbines may have less mass than piston-driven engines of equal power output. Hence, gas turbines may have greater power-to-mass ratios (specific power) than piston-driven engines of equal power output. Gas turbines also reject more heat at higher temperatures than piston-driven engines having equal power output. These characteristics of gas turbines provide several operational benefits. For example, the greater specific power can provide performance that is not achievable by other combustion technologies (e.g., sufficient thrust along with a low weight requisite for particular aircraft designs). Additionally, the greater heat output can enable efficiency gains by combining gas turbines with other systems. Cogeneration, for example, can include the combination of a gas turbine with a heating system that recaptures waste heat and increases the overall efficiency of the system.

Gas turbines may include a compressor, a combustor system having one or more combustion chambers (combustors), and a turbine. The compressor draws in and compresses air and delivers the resulting high pressure air to the combustor system. The combustor system provides fuel preparation and mixes the fuel with the compressed air within the combustors. The fuel-air mixture is ignited and burned in the combustors, and the resulting combustion gases and heated air then pass from the combustors through one or more flow directors such as nozzle guide vanes to the turbine. Pressure and energy are extracted from the flow of gases to drive the turbine and the compressor (both of which may be coupled to a common shaft). In jet engines, a relatively smaller portion of the turbine energy may be used to drive the compressor, and the remaining high pressure gases may be used to produce jet thrust for propulsion. In other designs, such as natural gas turbines for electrical generation, more energy may be extracted by the turbine to generate electrical energy via a generator coupled to the shaft.

The combustor system of a gas turbine may facilitate, contain, and maintain stable combustion through a wide range of fuel addition and air flow circumstances. Combustors also provide for the mixing of fuel and air particles, ignition of the resultant mixture, and containment during the combustion process. To improve efficiency, combustors are often carefully designed to provide vaporization of liquid fuels and/or preheating of slow burning fuels such as natural gas. A variety of combustor configurations have been developed to achieve the above-mentioned objectives. For example, combustor designs include types referred to as can, annular, and cannular. In addition to combustion within combustors, some gas turbines include various types of afterburners that can produce additional thrust via combustion outside of the combustors. Accordingly, the combustor system of a particular gas turbine can include features designed to operate in conjunction with an afterburner.

Combustor system design may be beneficial to achieving fuel efficiency, reducing objectionable emissions, and providing sufficient transient response to rapid changes of fuel flow, air speed, and air temperature and/or pressure. Combustor system design considerations include balancing several competing objectives that often require compromise between one another. For example, several competing objectives are listed below.

1) Providing adequate completion of fuel combustion at an air/fuel ratio, without stalling or wasting unburned fuel.

2) Reducing pressure losses and efficiency decreases from excessive resistance or constrictions within the air, fuel or combustion gas pathways of the combustor.

3) Maintaining the combustion process within the combustor.

4) Reducing non-uniform hot gas temperature profiles or “hot spots” within the combustors or in the exit flow. (Hot spots can rapidly damage the combustor cans and/or the turbine.)

5) Providing sufficient heat resistance and/or flow characteristics without increasing the overall weight or the dimensions of the turbine beyond constraints imposed by the particular application (e.g., weight and drag requirements for aircraft).

6) Providing satisfactory performance within a wide range of operating conditions.

7) Reducing emission levels, particularly with respect to oxides of nitrogen and particulates produced during transient operations. (Increasingly strict regulations have been imposed on aircraft emissions of pollutants and greenhouse gases, including oxides of nitrogen and carbon dioxide.)

FIG. 1 is a partially schematic cross-sectional view of a gas turbine or turbine 100 having a thermochemical regeneration (TCR) system 102, a compressor cooling system 104 and a fuel injection system 106 configured in accordance with an embodiment of the present disclosure. In the illustrated embodiment, the turbine 100 includes a compressor section 108, a combustion section 110, a turbine section 112 and an exhaust section 128. A casing 101 extends from a first or inlet end 103 of the turbine 100 to a second or exhaust end 105 and at least partially envelopes several of the internal processes and components. The compressor section 108 can include a plurality of rotors 109 that are operably coupled to a shaft 107 that may extend from the first end 103 to the second end 105. A plurality of stators 111 can be positioned within the compressor section 108, with individual stators 111 positioned adjacent to and downstream (i.e., in the direction of the second end 105) of corresponding rotors 109.

The combustion section 110 of the illustrated embodiment is a cannular design having a plurality of combustor cans 115 (two visible and identified individually as a first combustor can 115a and a second combustor can 115b). Fuel injectors 123 can include insulator tubes 124 and can be positioned in corresponding combustor cans 115 to deliver fuel for combustion. In some embodiments, the fuel injectors 123 can be injector-igniters, and can include ignition features for initiating combustion. Additionally, the injectors 123 can provide for rapidly adjustable fuel combustion patterns, including stratified zones of fuel combustion 125 within insulating compressed air to ensure completeness of combustion without hot spots or loss of combustion containment. The turbine section 112 can include a plurality of turbine rotors 137 operably connected to power shaft 107.

The gas turbine 100 can include several features and operational characteristics that may be similar to that of existing gas turbines. For example, air can be drawn in through the inlet end 103, compressed by the rotors 109 and stators 111 in the compressor section 108, and combined with fuel in the combustion section 110. The resulting fuel and air mixture can be ignited and combusted within the combustor cans 115, producing hot gases that can be directed through the turbine section 112 to provide a driving force for the shaft 107. The gases can then be directed through the exhaust section 128 and exit via the second end 105. Although the general operational characteristics described above may be similar to that of existing turbines, gas turbines configured in accordance with the present disclosure, including the gas turbine 100, can include one or more features that provide increased efficiency and/or increased power, as further described below.

Gas turbines configured in accordance with the present disclosure can include features that utilize Joule-Thomson (“JT”) expansion to provide expansive cooling or expansive heating. For example, as further described below, gases having a positive JT coefficient (e.g., hydrocarbon gases such as natural gas) can be expanded to produce cooling in the compressor section of a turbine to increase the efficiency and/or power output of a gas turbine. Similarly, gases having a negative JT coefficient (e.g., hydrogen) can be expanded to produce heating in the combustor section of a turbine to increase efficiency and/or power output.

The compressor cooling system 104 can increase the efficiency and/or power output of the gas turbine 100 by cooling air within the compressor section 108. For example, gases and/or liquid coolants can be transported to the compressor section 108 from the TCR system 102, or from a fuel supply system 117, via a plurality of conduits 114 and headers 118. Although shown schematically, it is to be understood that the headers 118 can include a variety of tubes, pipes, valves, actuators, switches, and/or other mechanical, electrical, or electromechanical components or devices to receive and direct various gases and/or liquids from one or more sources to one or more destinations. Similarly, the fuel supply system 117 can include multiple tanks, valves, pumps, headers, and/or other components to contain and deliver a variety of gaseous and/or liquid fuels including cryogenic or cold storage fuels such as LNG, H2, and various nitrogenous substances and hydrocarbons to multiple components. For example, although only one conduit 114 is shown extending to each of the injectors 123 of FIG. 1, it is to be understood that multiple conduits 114 can extend to the injectors 123 to provide multiple fuels that can be selectively injected, as further described below. Electrical cables 130 (e.g., signal and/or power cables) can operably connect the headers 118 to a controller 131 that can actuate the valves and/or other components of the headers 118 to control the flow of gases and/or liquids. For ease of illustration, cables 130 are shown connecting the controller 131 to some of the headers 118 and one of the fuel injectors 123. However, it is to be understood that the controller 131 can be connected to various components and systems of the gas turbine 100. Additionally, although the controller 131 is shown schematically as a single component, it is to be understood that the controller 131 can include various combinations of electronic control components and devices, including processors, circuits, sensors, converters, drivers, logic circuitry, input/output (I/O) interfaces, connectors or ports, computer readable media (e.g., random access memory (RAM), read-only memory, and/or non-volatile random access memory (NVRAM)), software, and/or other components to operate and control the gas turbine 100 and/or to interface with other systems, devices or machines (e.g., a flight control system of an aircraft employing the gas turbine 100).

The cooling system 104 can direct coolants to and from the compressor section 108 via an inlet 120 and an outlet 122. The inlet 120 and/or other components of the cooling system 104 can include an expansion valve that expands a gaseous coolant providing a temperature drop to the coolant. The inlet 120 and the outlet 122 can extend through the casing 101 and be operably connected via an internal coolant line 139 that extends through at least a portion of the compressor section 108. Specifically, the internal coolant line 139 can extend through at least a portion of the compressor (e.g., through one or more of the components including members such as one or more stators within the compressor section 108) to provide cooling of the airflow that is compressed within the compressor section 108. In the illustrated embodiment, the internal coolant line 139 extends through a portion of the casing 101 and through two of the stators 111. Air drawn into the compressor section 108 by the rotors 109 is directed through the casing 101 and past the stators 111. As the air passes through the portions of the casing 101 and the stator 111 having the internal coolant line 139, heat is transferred from the air to the coolant in the internal coolant line 139. Accordingly, the air is cooled and undergoes a commensurate decrease in volume, thereby reducing the amount of work required by the compressor section 108 to produce a desired final air pressure and volume. This reduced work by the compressor section 108 results in an improved efficiency and/or higher power output for the turbine 100.

In the illustrated embodiment, the cooling system 104 can utilize fluid coolant in the form of water vapor, fog or gaseous fuel from the fuel supply system 117, and/or other gases produced in the TCR system, as described further below. In some embodiments, the cooling system 104 can operate a refrigeration cycle that compresses and expands a dedicated coolant to drive a cooling cycle. In other embodiments, the coolant in the cooling system 104 can include exhaust products from the gas turbine 100 or other gases (e.g., methane, carbon monoxide, ammonia or nitrogen). Furthermore, in addition to extending through one or more stators 111 and/or a portion of the casing 101, the internal coolant line 139 can extend through dedicated heat exchangers or other components positioned to remove heat from air passing through the compressor section 108.

The cooling system 104 can also include an injection port 113 to provide direct cooling within the airflow of the compressor section 108. In the illustrated embodiment, the injection port 113 is operably coupled to the fuel supply system 117 and the TCR system 102 via the conduits 114 and headers 118. The injection port 113 can receive fluids including gaseous fuels from the fuel supply system 117 and/or from the TCR system 102 and expand them into the compressor section 108, resulting in a temperature drop for the expanded fuels. The cooled fuel can thus decrease the temperature of the airflow, increasing the efficiency of the compressor section 108. In addition to, or in place of, fuel from the fuel supply system 117 or the TCR system 102, other cooling gases can be directed through the injection port 113 and into the air flow of the compressor section 108. For example, carbon monoxide, ammonia, nitrogen and/or other gases can be injected into the compressor section 108 to provide cooling.

The exhaust section 128 can include a variety of components that can extract energy from the flow of gases and/or capture exhaust products from the gas stream. For example, in the illustrated embodiment the exhaust section 128 includes a plurality of helical fins 132 having fin tubes 133 extending therethrough. Fluid such as fuel and/or water can be directed through the fin tubes 133 of the fins 132, which collectively comprise a counter-current heat exchanger, to cool the exhaust stream and pre-heat the fuel and/or water. The pre-heated fuel and/or water can be directed to the TCR system 102 for TCR conversion, as further described below.

In addition to the helical fins 132, the exhaust section 128 can include an exducer 135 positioned to capture or otherwise extract substances such as water from the exhaust stream. In the illustrated embodiment, the exducer 135 includes a plurality of stator volutes 127 having cooling channels 134. Coolant fluids can be directed through the coolant channels 134 to cool the stator volutes and the exhaust stream flowing over them. Illustratively, water in the exhaust stream can condense on the stator volutes 127 and be directed to a water reservoir 116 via a collector 136 and a conduit 114. Although the exducer 135 in the illustrated embodiment includes a plurality of stator volutes 127, in other embodiments, the exducer 135 can include a rotor that slings condensates such as water out of the exhaust stream to the collector 136 for delivery to the reservoir 116.

The exducer 135 can be cooled by circulation of cool incoming fuel and/or precooled water through coolant channels 134 within each stator 137 or rotor. For example, the coolant channels 134 can be operably coupled to the fuel supply system 117 and/or the cooling system 104. Fuel that is directed through the coolant channels 134 to cool the exducer 135 for water removal can be subsequently directed to the fuel supply system 117, to the compressor section 108 or the combustion section 110 for combustion, and/or to the TCR system 102 for TCR conversion, as further described below.

Gas turbines configured in accordance with embodiments of the present disclosure can utilize a variety of gases that undergo JT cooling during expansion. For example, hydrocarbon gases such as natural gas, ethane and propane, and other fluids such as ammonia, carbon dioxide, carbon monoxide, water vapor or steam, oxygen, and nitrogen can be employed to provide increased efficiency. In some embodiments, these and/or other fluids can be provided to the gas turbine 100 from an external source. In several embodiments, however, these gases can be produced by the gas turbine 100, or components or systems thereof. Equations 1-5 (below) represent various reactions that can occur within components or systems of the gas turbine 100, as further described below. Reaction products from equations 1-5 can be used to provide cooling within the gas turbine 100 via expansive JT cooling, as described above.

CₓH_{y}+XH₂O+Heat₁→XCO+(y/2+X)H₂ Equation 1

CH₄+Heat→Carbon products+2H₂ Equation 2

CH₄+H₂O+HEAT→CO+3H₂ Equation 3

2NH₃+HEAT→N₂+3H₂ Equation 4

Urea or CO(NH₂)₂+HEAT→N₂+2H₂+CO Equation 5

Reactions such as shown by equations 1-5 can be carried out, for example, in the TCR system 102. As shown in FIG. 1, the TCR system 102 can be operably coupled to a variety of components of the gas turbine 100. For example, in the illustrated embodiment, the TCR system 102 is operably coupled to the exhaust section 128, the compressor cooling system 104 and the fuel injection system 106. The TCR system 102 can include a reactor 119, the fin tubes 133, a counter-current heat exchanger 121, the water reservoir 116, a pump 129, and a plurality of conduits 114 operably connecting these components in a variety of manners. Reaction products such as shown by equations 1-5 can be provided to the reactor 129 via the fuel supply system 117 and/or the water reservoir 116.

Equations 1-3 are examples of thermochemical regeneration (TCR) by which typical hydrocarbons such as diesel, jet fuel, natural gas, or other hydrogen donor fuels can be endothermically reacted to produce pressurized hydrogen-characterized gas for operation of a gas turbine engine. The amount of heat energy rejected through the hot exhaust gases by conventional gas turbine operation may be more than the heat requirement shown in equation 1. Combustion of hydrogen-characterized fuels (i.e., fuel mixtures including at least some hydrogen) can provide 15% to 30% more heat energy and provide heat release rates that are about 9 to 15 times greater than non-hydrogen characterized fuels. Furthermore, the negative JT coefficient of hydrogen can provide for expansive heating within combustors prior to or during combustion, thereby increasing combustion rate, pressure and power output. Additionally, combustion completion distances can be shortened in comparison to combustion of an original feed stock hydrocarbon. Rapid combustion in short distances can reduce hot spots or general overheating of components of the gas turbine 100 and/or provide for more compact designs.

Hydrogen-characterized fuels, and their precursor feed stocks, can produce adequate water vapor upon combustion to enable the reactions of equations 1 and 3. For example, the exhaust stream of the gas turbine 100 can provide about three times as much water as used for the conversion of natural gas or methane feed stock to hydrogen-characterized fuel, such as the TCR reaction of equation 3. Additionally, steam and/or pre-heated fuel exiting the fin tubes 133 can be close to the temperature of the exhaust gases from the turbine section 112. Such temperatures can be sufficient to drive the endothermic reactions of equations 1-5.

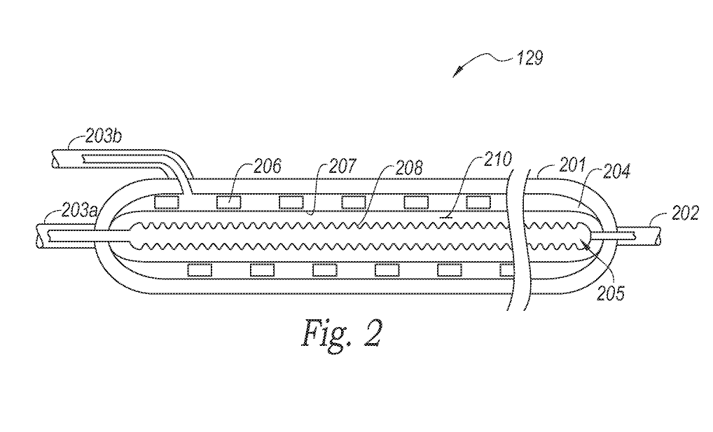

Various types or reactors 129 can be utilized to carry out TCR in accordance with the present technology. FIG. 2 is a schematic cross-sectional view of the reactor 129 of FIG. 1 configured in accordance with an embodiment of the present disclosure. In the illustrated embodiment, the reactor 129 includes an insulating canister 201, an inlet 202, and two outlets 203 (identified individually as a first outlet 203a and a second outlet 203b). A separator tube 204 having a tubular chamber 205 can be positioned within the canister 201 and receive pressurized and preheated fuels (e.g., methanol, ammonia, or mixtures of selected hydrocarbons such as natural gas and steam from the fin tubes 133 (FIG. 1)) through the inlet 202. The separator tube 204 can include a helical resistance and/or induction coil 206 that can further heat fuels and/or water within the reactor 129. The separator tube 204 can include a porous cathode 207, a porous anode 208, and a membrane 210 therebetween. Hydrogen ions can be driven to the cathode 207 via a pressure gradient and/or galvanic impetus from a voltage gradient controlled by the controller 131 (FIG. 1). The anode 208 can be a catalytic promoter of TCR reactions, such as those of equations 1-5. Pressurized gases and/or liquids can exit the reactor 129 via the outlets 203. Although the reactor 129 of FIG. 2 includes the anode 208 internal to the cathode 207, in other embodiments and duty cycles these relative positions can be reversed such as to perform cleaning operations.

The reactor 129 can produce pressurized hydrogen via multiple reactions and processes. For example, a sufficient voltage gradient between the anode 208 and cathode 207 can produce hydrogen via electrolysis. Additionally, pressurized hydrogen at 700 Bar (10,200 PSI) can be produced from waste (e.g., urea or acids that can be produced via anaerobic digestion), as shown in equation 5. Production of hydrogen from urea can require a far reduced amount of thermal and/or electrical power compared to ambient-temperature electrolysis of water. In the process of equation 3, methane can be reacted with steam in the reactor 129 to produce carbon monoxide and hydrogen. Similarly, the endothermic reaction of equation 4 can be carried out in the reactor 129 to produce hydrogen. In each instance combustion of the resultant hydrogen (e.g., in hydrogen-characterized fuel mixtures) can provide 15% to 30% more heat energy in comparison with combustion of the feed stock compound.

The reactor 129 can include one or more semipermeable membranes 210 that can assist in removing hydrogen from a production zone and increasing the pressure of the hydrogen. Proton conduction for such separation and pressurization can be provided by various ceramics and composites (e.g., carbon-fiber-reinforced graphene, silicon carbide or perovskite-type oxides). The hydrogen yield from the reactor 129 can be increased by functionalized substances including graphene, silicon carbide, and doped perovskite-type oxides. For example, enhanced proton conductivity can be provided by doped SrCeO₃, CaZrO₃, BaCeO₃ and/or SrZrO₃. Suitable dopants include yttrium, ytterbium, europium, samarium, neodymium, and gadolinium.

In addition to dopants, hydrogen separation by oxide ceramics can be enhanced by increased pressure gradients and/or application of a DC bias. In non-galvanic hydrogen separation processes that include pressure differentials, hydrogen may be transported from a membrane side having a higher partial pressure of hydrogen to a side having a lower partial pressure of hydrogen. In contrast, in embodiments employing a DC bias or galvanic drive in the hydrogen separation process, the hydrogen can permeate from a lower partial pressure of hydrogen produced on one side of a membrane to a higher partial pressure of hydrogen on the other side, or vice versa according to process mode designation by controller 131.

The rate of hydrogen production within the reactor 129 can also be influenced by the heat provided by the exhaust section of the gas turbine 100 (FIG. 1). For example, increased heat can shift the reactions of equations 1-5 toward greater yields and/or allow higher reactant pressures without reducing yields. Improvement in reaction rate and/or yield may be further provided by removal of a product such as hydrogen as it is formed to shift the reaction toward the products. Additionally, catalysts may be utilized at a reaction surface to favorably influence surface exchange reactions such as those of equations 1-5. For example, hydrogen permeation and thus the process yield can be enhanced by coating the membrane with a surface catalyst to reduce the activation energy for the surface exchange reactions. To some extent some anode material selections may be favorable catalysts. Anodes of galvanic hydrogen pumps include porous films of Ni, Ag, Pt, and Ni/BCY porous layers. In such hydrogen pumping processes, the gas mixture in the anode and cathode zones can include steam or be humidified with water vapor to improve the proton conductivity of the electrolyte and suppress its electronic conductivity.

In accordance with Faraday's law, hydrogen separation rates increase as the applied current in the electrode 206 is increased. Depending upon factors such as reactant pressure and temperature, dopant selection, membrane thickness, and humidity, applied galvanic voltage gradients in the range of, e.g., 0.2 to 20 Volts DC are adequate to produce substantially higher pressure hydrogen. Such net bias of galvanic voltage gradients may be produced by much higher voltage AC or DC electricity delivered to resistive and/or inductive heating of the reactor-separator tube.

Various mixtures of reactants and products such as hydrogen along with CO, CO₂, H₂O, and/or N₂ at or near the anode 208 can be separated to provide pressurized hydrogen at the cathode 207. Such hydrogen pressurization driven by an applied external voltage can move hydrogen from a suitably pressurized gas mixture such as lower pressure to assure high yield efficiency, including reactants and products, to higher pressure for product delivery such as hydrogen for denser storage and injection purposes. Pressurized gases for expansive cooling can be collected at the anode 208 of the membrane for injection and expansive cooling within the compressor section 108 (FIG. 1), and pressurized hydrogen from the cathode 207 can be collected at high pressure for injection into the combustors 115 (FIG. 1) to produce expansive heating.

Endothermic heat can be added in various steps, including heat from engine exhaust gases at around 425° C. (800° F.) or higher temperatures, and heat from electrical bias, inductive heating, and/or resistance heating at about 650 ° C. to about 1600° C. (1200° F. to 2900° F.). The heat can be controlled via the controller 131 (FIG. 1) to achieve the conversion rate and pressurization of hydrogen for the operation of the gas turbine 100. Renewable or regenerative sources of energy for heat can include regenerative deceleration of a vehicle, utilization of suspension energy from regenerative shock absorber/spring systems, energy conversion streamlining of a vehicle, or utilization of off-peak electricity in stationary applications.

Depending upon the pressure desired for hydrogen storage, a flow circuit may be utilized that provides for reactants to first gain a portion of heat from exhaust gases and then enter into the reactor 129 to utilize galvanic hydrogen separation and pressurization. This can provide a thermal gradient from exhaust gases to supply the first portion of heat, and also provide flexibility to the process by enabling rapid application of regenerative energy (e.g., electrical energy) to provide additional heat at higher adaptively controlled temperatures as may be used to produce hydrogen at the desired rate and/or pressure for direct injection and stratified charge combustion in gas turbine operations.

The TCR system 102 of the present disclosure can include one or more components, devices or systems, described in U.S. patent application Ser. No. 13/684,987, entitled CHEMICAL PROCESSES AND REACTORS FOR EFFICIENTLY PRODUCING HYDROGEN FUELS AND STRUCTURAL MATERIALS, AND ASSOCIATED SYSTEMS AND METHODS, and filed Nov. 26, 2012; U.S. patent application Ser. No. 13/027,244, entitled THERMAL TRANSFER DEVICE AND ASSOCIATED SYSTEMS AND METHODS, and filed Feb. 14, 2011; U.S. patent application Ser. No. 13/481,673 entitled REACTORS FOR CONDUCTING THERMOCHEMICAL PROCESSES WITH SOLAR HEAT INPUT, AND ASSOCIATED SYSTEMS AND METHODS, and filed May 25, 2012; U.S. patent application Ser. No. 13/685,075 entitled INDUCTION FOR THERMOCHEMICAL PROCESS, AND ASSOCIATED SYSTEMS AND METHODS, and filed Nov. 26, 2012; and U.S. patent application Ser. No. 13/584,749 entitled MOBILE TRANSPORT PLATFORMS FOR PRODUCING HYDROGEN AND STRUCTURAL MATERIALS, AND ASSOCIATED SYSTEMS AND METHODS, and filed Aug. 13, 2012, each of which is incorporated by reference herein in its entirety.

In the combustion section 110 (FIG. 1), hydrogen can be injected via the injectors 123 and expanded into the gases from the compressor section 108 to produce heat and accelerate the combustion of other fuels that may be present (including fuel fluids previously added through the compressor section 108). In instances that expansive cooling fuel fluids are directed through the internal coolant lines 139 of the stators 111 to cool air undergoing compression, such fuel gases can be injected as a mixture with hydrogen by the injectors 123 to provide accelerated hydrogen-boosted combustion. The expansive cooling of air in the compressor section 108 and the expansive heating of fuel and air in the combustion section 110 can both improve the effective brake mean effective pressure (BMEP) and fuel efficiency of the gas turbine 100.

The fuel injectors 123 can be of any suitable design and arrangement for injecting fuels, such as those produced by TCR. Compared to diesel and jet fuels, fuels produced via TCR (e.g., hydrogen and mixtures of hydrogen and gases such as nitrogen, carbon monoxide, carbon dioxide, gaseous hydrocarbons and other compounds) are up to about 3,000 times lower in volumetric energy density. Accordingly, larger volumes of such fuels must be used to produce sufficient power output. Hence, turbine operation may be improved by injectors or injector-igniters that can rapidly inject large volumes and/or efficiently ignite large volumes.

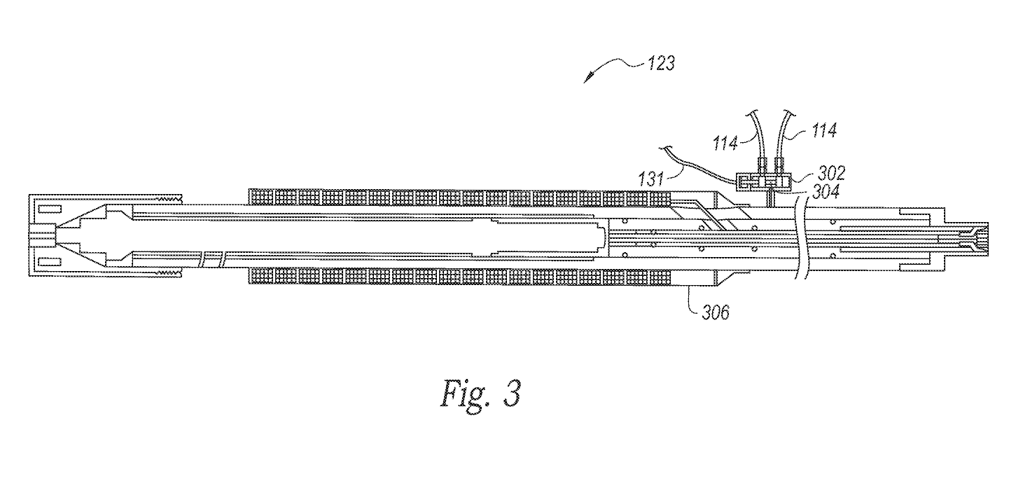

FIG. 3 is a cross-sectional schematic view of the injector-igniter 123 configured in accordance with an embodiment of the present disclosure. The injector 123 can provide rapid selection of any of several fuels or fluids by a thermally isolated and/or insulated flow director 302. Conduits 114 and a control cable 131 can be operably coupled to the flow director 302 to provide fuel and control and ignition signals, respectively as scheduled by controller 131 and/or by a microcontroller within 123. A motion amplifier can magnify motion of a piezoelectric component of the flow director 302 to position a heat resistant shuttle valve 304 (e.g., a ceramic or super alloy valve). The flow director 302 can be integral with an elongated injector body 306 or mounted in any suitable orientation with respect to the injector body 306. The injector-igniter can include ignition coils, transformer sections, glass or ceramic insulator sleeves, capacitors and/or a variety of other components or devices associated with fuel injectors, igniters and/or injector-igniters.

The length of the injector-igniter 123 may be as long as needed to extend into a hot zone of the combustors 115 (FIG. 1). Additionally, the injector 123 can be positioned to provide a desired angle of fuel projection into the combustion air to develop directional momentum of the JT expansion heating and combustion thrust into the power rotor section of the turbine section 112. The injector 123 can include a sheath having one or more fins or other features to produce desired flow patterns of gases delivered from the compressor section 108. The flow patterns can be chosen to help reduce the flame length of fuel combustion, impart a desired flow to increase the conversion efficiency by the turbine section 112, and/or to eliminate potentially damaging hot spots in the hot gases flowing to the turbine section 112.

The embodiments provided by the present disclosure may benefit thermal and fuel efficiencies.

The combustion of hydrogen-characterized fuels, along with the injection and ignition system disclosed herein, can provide several advantages with respect to gas turbine designs. For example, combustors can be much lighter and smaller than conventional designs. Additionally, one or more injector-igniters can provide changes in fuel rate to meet transient conditions. Combustion assurance and flame containment can be enhanced by TCR fuel products, without air-fuel premixing as is required with conventional fuel selections such as jet fuel and natural gas. The injectors may provide a benefit to ignition assurance throughout widely varying fuel rates, and fuel combustion patterns can be quickly adjusted to provide stratified zones of fuel combustion within insulating compressed air to ensure completeness of combustion without hot spots or loss of combustion containment.

I/We claim:

1. A gas turbine comprising:
a compressor section including:
a rotor operably coupled to a shaft;
a stator positioned adjacent to the rotor; and
a coolant line extending at least partially through the stator to transfer heat out of an air flow within the compressor section.

2. The gas turbine of claim 1, further comprising a fuel supply system, wherein the coolant line is operably coupled to the fuel supply system, and wherein fuel from the fuel supply system flows through the coolant line.

3. The gas turbine of claim 1, further comprising a thermochemical regeneration system having a reactor, wherein the reactor produces hydrogen for combustion within the gas turbine.

4. The gas turbine of claim 1, further comprising an injection port positioned to inject fuel into the compressor section.

5. The gas turbine of claim 1, further comprising:
a plurality of combustors;
a thermochemical regeneration system having a reactor configured to produce hydrogen-characterized fuels; and
a fuel injection system operably coupled to the reactor and having a plurality of fuel injectors, wherein individual fuel injectors are positioned to inject fuel into corresponding combustors.

6. The gas turbine of claim 1, further comprising a plurality of injector-igniters positioned to inject and ignite fuel within the gas turbine.

7. The gas turbine of claim 1 wherein the coolant line carries fuel, and wherein the fuel is combusted within the gas turbine after passing through the coolant line.

8. A gas turbine comprising:
a combustion section having a plurality of combustors;
a plurality of injectors, individual injectors positioned within corresponding combustors;
a compressor section having a stator; and
a cooling system having a coolant line that extends at least partially through the stator, wherein fuel is directed through the coolant line to cool airflow within the compressor prior to injection of the fuel into the combustors via the injectors.

9. The gas turbine of claim 8 wherein the injectors comprise injector-igniters configured to inject the fuel into the combustors and ignite the fuel.

10. The gas turbine of claim 8, further comprising:
a fuel supply system; and
a thermochemical regeneration system operably coupled to the fuel supply system, the thermochemical regeneration system including:
a plurality of fin tubes extending through an exhaust section, wherein fuel is directed through the fin tubes and heated by exhaust from the gas turbine;
an exducer positioned to capture water from the exhaust; and
a reactor positioned to receive the fuel from the fin tubes and receive the water from the exducer, wherein the reactor is configured to react the fuel and the water to produce hydrogen for combustion in the gas turbine.

11. The gas turbine of claim 8, further comprising an exhaust section having an exducer positioned to capture water from an exhaust stream of the gas turbine.

12. The gas turbine of claim 11 wherein the exducer comprises a plurality of stator volutes.

13. The gas turbine of claim 8, further comprising an injection port positioned to inject fuel into the compressor section.

14. The gas turbine of claim 8 wherein individual injectors include corresponding insulator tubes.

15. A method for operating a gas turbine, the method comprising:
cooling an air flow in a compressor section of the gas turbine by directing fuel through an internal coolant line extending through at least a portion of the compressor section;
injecting the fuel into a combustor via an injector; and
igniting the fuel within the combustor.

16. The method of claim 15, further comprising producing hydrogen in a thermochemical regeneration system that is operably coupled to the gas turbine and injecting the hydrogen into the combustor via the injector.

17. The method of claim 15, further comprising capturing water from an exhaust stream of the gas turbine and directing the water to a thermochemical regeneration system.

18. The method of claim 15, further comprising pre-heating fuel in a counter-current heat exchanger positioned to utilize heat transfer from the exhaust of the gas turbine and directing the fuel through a thermochemical regeneration system.

19. The method of claim 15, further comprising injecting fuel into the compressor section via an injection port.

20. The method of claim 15, further comprising combining fuel with water from the exhaust stream of the gas turbine to produce hydrogen for combustion within the gas turbine.
